(19) United States
(12) Patent Application Publication
(10) Pub. No.: US 2023/0023812 A1
(43) Pub. Date: Jan. 26, 2023

(54) SYSTEM AND METHOD FOR USING A NEURAL NETWORK TO FORMULATE AN OPTIMIZATION PROBLEM

(71) Applicant: KING ABDULLAH UNIVERSITY OF SCIENCE AND TECHNOLOGY, Thuwal (SA)

(72) Inventors: Bingbing SUN, Thuwal (SA); Tariq Ali ALKHALIFAH, Thuwal (SA)

(21) Appl. No.: 17/783,323

(22) PCT Filed: Nov. 19, 2020
(86) PCT No.: PCT/IB2020/060940

§ 371 Date: Jun. 8, 2022

Related U.S. Application Data
(60) Provisional application No. 62/990,218, filed on Mar. 16, 2020.
(60) Provisional application No. 62/945,488, filed on Dec. 9, 2019.

(51) Int. Cl. G01V 1/50; G01V 1/28

(52) U.S. Cl. CPC G01V 1/50; G01V 1/282; G01V 2210/51

(57) ABSTRACT

A method for waveform inversion, the method including receiving observed data d, wherein the observed data d is recorded with sensors and is indicative of a subsurface of the earth; calculating estimated data p, based on a model m of the subsurface; calculating, using a trained neural network, a misfit function J_{ML}; and calculating an updated model mₜ₊₁ of the subsurface, based on an application of the misfit function J_{ML} to the observed data d and the estimated data p.

### CROSS-REFERENCE TO RELATED APPLICATIONS

This application claims priority to U.S. Provisional Patent Application No. 62/945,488, filed on Dec. 9, 2019, entitled “A METHOD FOR USING A NEURAL NETWORK TO FORMULATE AN OPTIMIZATION PROBLEM,” and U.S. Provisional Patent Application No. 62/990,218, filed on Mar. 16, 2020, entitled “SYSTEM AND METHOD FOR USING A NEURAL NETWORK TO FORMULATE AN OPTIMIZATION PROBLEM,” the disclosures of which are incorporated herein by reference in their entirety.

### BACKGROUND

### Technical Field

Embodiments of the subject matter disclosed herein generally relate to a system and method for applying a neural network to an optimization problem, and more particularly, to using a neural network for providing a trained misfit function that estimates a distance between measured data and calculated data.

### Discussion of the Background

To find a solution to a specific problem, it is often the case that inverse theory is used to form an optimization function. The maximum or minimum of such optimization function answers such an inverse problem. This process is often used to extract information from the observed data (e.g., seismic data describing a portion of the earth). Specifically, it is customary to first simulate data for the object of interest (e.g., a subsurface of the earth that may include an oil and gas reservoir) using the best knowledge of the physics (i.e., using a model that relies on the physics) involved with that object and then minimize a mathematical difference between the simulated data and the observed/measured data, based on the optimization function, by adjusting the parameters of the model. When the minimum or maximum is reached, the model that generates that estimated data is considered to be the one that best describes the object. That model is then used to make various predictions about the object.

A measure of the difference between the observed data and the simulated data can be accomplished by applying a distance measurement between the two data vectors (observed and simulated). A single scalar value of the optimization function, often referred to as the misfit function, will be obtained for representing the degree of difference between the two sets of data. The misfit function, that quantifies the difference measurement is then used alongside a gradient-descent (ascent) method, or any higher-order derivative of the misfit function, to update the model corresponding to the object of interest and then the process is repeated until the optimization function is minimized or maximized.

Because the relation between the model's parameters of interest and the data is often nonlinear, the inversion process can encounter many calculation complications. Such complications are often addressed by developing advanced functions that measure the distance (misfit) between the observed and simulated data, beyond the commonly used least-squares approach. Hand-crafted misfit functions work fine for some practical cases (such as the L2-norm misfit for the least-squares approach), but they may fail for other cases, depending on the data and coverage.

Thus, there is a need for a new approach for generating the misfit function, that is applicable to any real case, and adapts better to the available data.

### BRIEF SUMMARY OF THE INVENTION

According to an embodiment, there is a method for waveform inversion, and the method includes receiving observed data d, wherein the observed data d is recorded with sensors and is indicative of a subsurface of the earth; calculating estimated data p, based on a model m of the subsurface; calculating, using a trained neural network, a misfit function and calculating an updated model mₜ₊₁ of the subsurface, based on an application of the misfit function J_{ML} to the observed data d and the estimated data p.

According to another embodiment, there is a computing system for waveform inversion, and the computing system includes an interface configured to receive observed data d, wherein the observed data d is recorded with sensors and is indicative of a subsurface of the earth; and a processor connected to the interface. The processor is configured to calculate estimated data p, based on a model m of the subsurface; calculate, using a trained neural network, a misfit function J_{ML}; and calculate an updated model m_{t·1} of the subsurface, based on an application of the misfit function J_{ML} to the observed data d and the estimated data p.

According to yet another embodiment, there is a method for calculating a learned misfit function J_{ML} for waveform inversion. The method includes a step of selecting an initial misfit function to estimate a distance between an observed data d and an estimated data p, wherein the initial misfit function depends on a neural network parameter θ, the observed data d, and the estimated data p, which are associated with an object; a step of selecting a meta-loss function J_{META} that is based on the observed data d and the estimated data p; a step of updating the neural network parameter θ to obtain a new neural network parameter θ_{new}, based on a training set and a derivative of the meta-loss function J_{META}; and a step of returning a learned misfit function J_{ML} after running the new neural network parameter θ_{new} in a neural network for the initial misfit function.

According to still another embodiment, there is a computing system for calculating a learned misfit function J_{ML} for waveform inversion. The computing system includes an interface configured to receive an initial misfit function to estimate a distance between an observed data d and an estimated data p, wherein the initial misfit function depends on a neural network parameter θ, the observed data d, and the estimated data p, which are associated with an object; and a processor connected to the interface. The processor is configured to select a meta-loss function J_{META} that is based on the observed data d and the estimated data p; update the neural network parameter θ to obtain a new neural network parameter θ_{new}, based on a training set and a derivative of the meta-loss function J_{META}; and return the learned misfit function J_{ML} after running the new neural network parameter θ_{new} in a neural network for the initial misfit function.

According to still another embodiment, there is a computing device for calculating a regularization term for a waveform inversion model. The computing system includes an interface configured to receive an initial measure of the regularization term, wherein the initial measure of the regularization term depends on a neural network parameter θ, and a current or final model m, which corresponds to an object; and a processor connected to the interface. The processor is configured to select a meta-loss function J_{META} that is based on the observed data d and the estimated data p, or a true and current model of the object; update the neural network parameter θ to obtain a new neural network parameter θ_{new}, based on a training set and a derivative of the meta-loss function J_{META}; and return the learned regularization after running the new neural network parameter θ_{new} in a neural network for the initial measure of the regularization term.

### BRIEF DESCRIPTION OF THE DRAWINGS

Fora more complete understanding of the present invention, reference is now made to the following descriptions taken in conjunction with the accompanying drawings, in which:

FIG. 1 illustrates a neural network representation for a misfit function that is calculated by machine learning;

FIG. 2 is a flowchart of a method for calculating the misfit function based on the machine learning;

FIG. 3 is a flowchart of a method for training a neural network that is used to generate the misfit function;

FIG. 4 illustrates a subsurface of the earth to which the misfit function is applied for generating a model of the subsurface;

FIG. 5 illustrates the loss over epochs for training the misfit function for a time-shift example;

FIG. 6 illustrates the convexity for the misfit function and a L2 norm misfit over a number of 800 epochs;

FIGS. 7A to 7C illustrate the convexity evolution for the misfit function and the L2 norm misfit over different numbers of epochs when a Hinge loss function is added to the misfit function;

FIGS. 8A and 8C illustrate the convexity evolution for the misfit function and the L2 norm misfit over different numbers of epochs when the Hinge loss function is not added to the misfit function; and

FIG. 9 illustrates a computing device in which any of the methods discussed herein can be implemented.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a system and method that uses a neural network (NN) approach to formulate an optimization problem in the context of seismic imaging of a subsurface of the earth for detecting an oil or gas reservoir. However, the embodiments to be discussed next are not limited to such specific problem, but may be applied to any case in which it is necessary to formulate an optimization problem.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel approach for determining the misfit function is introduced and this approach utilizes machine learning to develop the misfit function that adapts better to the data. The misfit function determined by machine learning (ML) is referred herein to the ML-misfit function J_{ML}.

As previously discussed, within the optimization framework, an objective (also called cost or misfit or loss) function is used to measure the difference between the estimated data, i.e., the data calculated based on a model, and the observed data, i.e., the data acquired by a system. This measure of the difference between the estimated and observed data is often accomplished by using a specific norm that relies mainly on the subtraction of every element of one data from the corresponding element of the other data. In specific applications related to waveform inversion, which are used in the oil and gas field, these kind of misfits suffer from cycle skipping between the data. Similar cycle-skipping issues are encountered when using a misfit function that measures the similarity between the data like the correlation (dot product) misfit.

More global methods that utilize a matching filter have shown considerable promise in mitigating the cycle-skipping issues. However, these hand-crafted misfit functions often work well with specific data, and encounter challenges when the physics of the system is not addressed properly.

Waveform inversion is an important tool for delineating the Earth using the measurements of seismic or electromagnetic data (illuminating the medium with such waves). The propagation of seismic (sonic, sound) and electromagnetic waves (or waves in general) in a medium is influenced by the properties of the medium, and especially the sources of the waves as well as their scattering objects. Thus, for a typical seismic survey, one or more seismic sources (for example, a vibrator) are used to impart seismic energy to the earth to generate the seismic waves. The seismic waves propagate through the earth and get reflected and/or refracted at various interfaces where the speed (or the elastic properties in general) of the wave changes. These reflected and/or refracted waves are then recorded with seismic receivers (e.g., hydrophones, geophones, accelerometers, etc.) at the earth's surface. When the seismic waves are recorded, their properties can be extracted, or a representation of them, in a process that is known as inversion.

Classic inversion methods suffer from the sinusoidal nature of seismic waves, and thus, they face issues related to cycle skipping and the highly nonlinear relation between the medium properties and the wave behavior. Improvements in the performance of waveform inversion is desired to many applications as the cost of the process is high.

The reflected and/or recorded waves that are recorded with the seismic sensors over time may originate not only from manmade sources, as the vibrators noted above, but also from natural sources, including ambient noise, which is now prevalent in many applications ranging from medical imaging, reverse engineering, nondestructive testing, and, of course, delineating the Earth physical properties. The resulting signals carry information of the object they originated from and the medium they traveled through. The states of these waves as a function of space and time are referred to as wavefields. These functions depend on the source of the wavefield energy and the medium they reside within.

These wavefields can be solved using the appropriate wave equations (considering the physical nature of the medium), for a given source of the energy (location and signature) and specified medium properties. If any of the given information does not accurately represent the source and the real medium properties, the wavefield would usually be damaged and its values at the sensor locations would differ from those measured in the real experiment. For classic waveform inversion, such differences are measured in many ways to update the source information and the medium properties or at least one of them.

However, according to an embodiment discussed herein, a new approach is introduced for measuring the data difference. The measure of the difference between the observed data in the field and the simulated data is often performed using a least-squares L2 norm measure. In spite of its potential for high-resolution results, it is prone to cycle-skipping.

According to this embodiment, a machine learning architecture is used to generate the objective function or the measure. Although this novel approach is applicable to any machine learning architecture capable of learning to measure a difference between data for optimization purposes, in this embodiment, a specific category of machine learning algorithms is discussed. This category is discussed within the framework of meta-learning. Meta-learning includes ML algorithms that try to learn from observations on how other neural networks perform and then establish a system that learns from this experience (learning to learn).

Before discussing the novel approach that uses an ML-misfit function, a brief introduction to the traditional approach of the waveform inversion is believed to be in order. The waveform inversion relies on a model m that describes the properties of the subsurface under an assumed physics of wave propagation that describes the interaction between the seismic waves and the subsurface, a forward operator forward, which is the forward extrapolation (modeling) of a wavefield, and a source s, which is the source of the wavefields. With these quantities, the following equations define the conventional waveform process for finding the model m:

(m*,s*)=optimize{J[d,p(m,s)]} such that p=forward[m](s), (A)

where the star * indicates the solution for a given parameter, and the term “optimize” stands for some minimum or maximum of the misfit function J, which achieves some measurement of similarity or difference between the elements (vectors) present in the square brackets, which are separated by the comma. Such measure can be applied to the data directly or to a representation of the data, like the phase, amplitude, envelope, etc. of the data. The modeled data p or any version of it is obtained by applying the operator “forward” to the source s while using the model m.

The linearized (or quadratic) update is given by:

m*=m+Δm or f*=f+Δf (Δm,Δf)=inverse[m](d,p), (B)

where the operator “inverse” could be the Born inverse (for example, the first term of the Born series). This operator could also include the inverse of the Hessian or any approximation of it. Conventional representations of the operator “optimize” can make the inversion process to suffer from a high level of nonlinearity between the data and the perturbations in the model.

As already mentioned, the most conventional form of “optimize” is given by the least square difference between the observed d and the simulated data p, which can be implemented as follows:

$$optimize \{ J [ d , p ( m , f ) ] \} = {min}_{[ m , f ]} {‖ d - p ( m , f ) ‖}^{2} \qquad ( C )$$

where ∥·∥² is the L2 norm consisting of squaring the difference between the observed and simulated data per element and summing those differences to obtain a single value measure. However, due to the high nonlinearity between the simulated data and the model parameters, this optimization can fall into a local minimum, when gradient-based methods in the optimization are used.

This problem is avoided by the novel method now discussed in this embodiment. More specifically, an ML-misfit function J_{ML} is introduced and this function is implemented using the meta-learning. The meta-learning (see [1] and [2]) is an automatic learning methodology in ML. The meta-learning is flexible in solving learning problems and tries to improve the performance of existing learning algorithms or to learn (extract) the learning algorithms itself. It is also referred to as “learning to learn.”

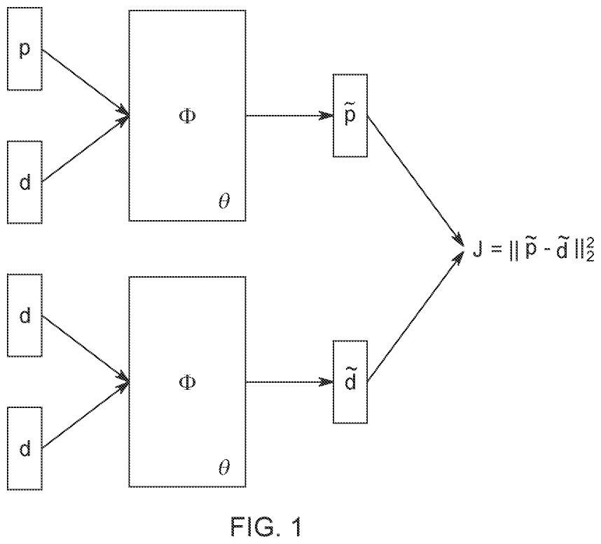

The misfit function for optimization problems takes the predicted data p and the measured data d as input and outputs a scalar value that characterizes the misfit between these two sets of data. For simplicity, in the following, the time coordinate t and space coordinate xₛ for the source and the space coordinate xᵣ for the seismic receiver (or sensor) are omitted. The novel machine learned ML-misfit function J_{ML} has a first term having a general NN representation as illustrated in FIG. 1, but it could have other representations as well. To better constrain the function's space and stabilize the training of the neural network, the following NN architecture for the ML-misfit function J_{ML} is used:

J_{ML}(p,d)=∥Φ(p,d; θ)−Φ(d,d; θ)∥₂²+∥Φ(d,p; θ)−Φ(p,p; θ)∥₂², (1)

where Φ(p, d; θ) is a function that represents the neural network illustrated in FIG. 1, having the input p and d in vector form (in this example a single trace, but it could be multi-trace) and the output J is also a vector, and the neural network parameter is θ. Note that FIG. 1 generically illustrates that the function J depends on the difference of \tilde{p} and \tilde{d}, which are the outputs of function Φ for different inputs. Further, the function J also depends on the neural network parameter θ, which means that as the NN is trained, this parameter changes, improving the misfit function. The form of the misfit function in equation (1) is based on the optimal transport matching filter (OTMF) misfit discussed in [3]. However, the OTMF is not a trained misfit function, i.e., it does not depend on the neural network parameter θ as the function in equation (1) does. Note that FIG. 1 shows the neural network only for the first term in equation (1).

The neural network function representation Φ(p, d; θ) tries to characterize the similarity between p and d in a global sense, and its output is expected to be similar to the mean and variance in the OTMF approach. Thus, in this embodiment, an L2 norm measurement is used of the above neural network function representation Φ(p, d; θ), which includes the input of the same data d to the function Φ(d, d; θ), to measure the departure of p from d. The second term in equation (1) is introduced to achieve a symmetry of the misfit function (i.e., d and p are interchangeable).

Thus, the ML-misfit function satisfies the following requirement for a metric (distance):

$${J}_{M L} ( p , d ) \geq 0 , \qquad ( 2 )$$

$${J}_{M L} ( f , f ) = 0 ⇔ f = f \qquad ( 3 )$$

$${J}_{M L} ( p , q ) = {J}_{M L} ( q , p ) , \qquad ( 4 )$$

where p, d, f, and q are arbitrary input vectors.

Another requirement for a metric or distance function is the “triangle inequality” rule, which requires that:

J_{ML}(p,q)≤J_{ML}(p,n)+J_{ML}(n,q), (5)

where n is a vector in the space shared by p and d. The ML-misfit function given by equation (1) does not automatically fulfill this requirement. Thus, in this embodiment, a Hinge loss regularization function is introduced to make the ML-misfit function of equation (1) comply with the triangle inequality of equation (5). The Hinge loss regularization function R_{HL} is given by:

R_{HL}(p,q,n)=max(0,J_{ML}(p,q)−J_{ML}(p,n)−J_{ML}(n,q)). (6)

It is observed that if the “triangle inequality” rule of equation (5) holds for the ML-misfit function, the Hinge loss function of equation (6) would be zero. The application of the Hinge loss regularization is discussed in more detail in the next section, which is related to the training of the neural network.

In waveform inversion, for a given model mₜ at a current iteration t, the method performs the forward modeling to obtain the predicted data pₜ for that iteration. Note that the model mₜ describes the physics of the medium (e.g., subsurface) and the interaction between the seismic waves and the medium. The derivative of the ML-misfit function with respect to the predicted data p gives the adjoint source δs (similar to data residual) as follows:

$$δ s = \frac{\partial {J}_{M L} ( {p}_{t} , d ; θ )}{\partial p} . \qquad ( 7 )$$

The adjoint source δs is dependent on the parameters of the ML-misfit function J_{ML} that is obtained by NN. This dependence is relevant as later the method will reverse the forward process to update the parameter θ of the NN of the ML-misfit function.

The method back propagates the adjoint source δs (which is in general equivalent to applying a reverse time migration (RTM) operator to the residual) to get the model perturbation γRTM, for updating the model m:

mₜ₊₁=mₜ−γRTM(sₜ), (8)

where γ is the step length and the RTM operator is the adjoint operator of the Born modeling approximation.

Using the updated model mₜ₊₁, it is possible to simulate the predicted data pₜ₊₁ and iteratively repeat this process to update the model until the ML-misfit function of the waveform inversion reduces to a minimum or maximum value. This process is similar to a conventional iterative waveform inversion process, except for replacing the conventional misfit function with a machine learned misfit function, i.e., the ML-misfit function.

Because the ML-misfit function is obtained using the NN, it is necessary to introduce a way to update the parameter θ of the neural network. Note that the dependence of the pₜ data on the NN parameter θ is through the model mₜ₊₁, which also depends on the parameter θ through the adjoint source δs. Considering there is such relation between the predicted data pₜ₊₁ and the parameter θ of the neural network, it is possible to define, in one application, the meta-loss function J_{META} as the accumulated L2 norm of the data residual, i.e.,

$${J}_{META} = {\sum }_{{t}^{′} = t}^{t + k} {‖ {p}_{{t}^{′}} - d ‖}_{2}^{2} , \qquad ( 9 )$$

where k is an unroll integer, which is selected based on experience, and may have a value between 0 and 20. An alternative meta-loss function can be defined, according to another application, as the accumulated L2 norm of the model residual, i.e.,

$${J}_{META} = {\sum }_{{t}^{′} = t}^{t + k} ‖ {m}_{{t}^{′}} - {m}_{true} {‖}_{2}^{2} . \qquad ( 10 )$$

where m_{t′} is the model updated for iteration t′ and mₜᵣᵤₑ is the actual model of the subsurface.

Then, by computing the derivative of the meta-loss function J_{META} with respect to the parameter δ, e.g., by gradient-descent, a new value θ_{new} for the parameter θ can be obtained, as follow:

$${θ}_{n e w} = θ - β \frac{\partial {J}_{META}}{\partial θ} , \qquad ( 11 )$$

where β is the learning rate.

The optimization problem in this case acts on both the medium parameter model m and the neural network model defined by Φ(p, d; θ). For this approach, it is desired to define an objective function for updating the parameter θ of the neural network model Φ(p, d; θ). Thus, for updating the neural network model parameter θ, it is possible to use the original objective of trying to minimize the difference between the observed and simulated data, or any variation of this. There are many ways to do so including the simplest and most widely used measure of difference given by equation (A). In this form, the optimization problem has been split in the training stage into two subproblems:

$${θ}^{*} = {min}_{θ} {‖ d - p ( m , δ s , θ ) ‖}^{2} \qquad ( 12 )$$

$$( {m}^{*} , δ {s}^{*} ) = {min}_{[ m , s ]} {J}_{M L} ( p , d ; θ ) , \qquad ( 13 )$$

with the first equation being used to update the NN parameter θ and the second equation being used to update the model m and the adjoint source δs.

These two subproblems may be solved using iterative gradient methods and they may be performed simultaneously so that the updated parameters θ_{new}, m and δs can be used in the other optimization problem subproblem. In one application, it is possible to allow one of the subproblems (equation (12) or (13)) to mature more (use more iterations) before solving the other subproblem.

The updating of the parameter θ of the NN requires the method to deal with high-order derivatives, i.e., the gradient of the gradient. This is because the adjoint source δs is the derivative of the ML-misfit function. Thus, updating the neural network further needs the computation of its derivative with respect to the parameters and this can be considered to be equivalent to the Hessian of the ML-misfit function with respect to the NN parameter θ. Most machine learning frameworks include modules for high-order derivatives, such as in Pytorch, using the module “torch.autograd.”

For the training of the ML-misfit function, the meta-loss function J_{META} defined in equations (9) and (10) can have regularization terms, such as the L1 norm for sparsity regularization of the neural network parameter θ. Specifically, in one implementation, it is possible to add the Hinge loss function of equation (6) as the regularization to force the resulting ML-misfit function to comply with the “triangle inequality” rule. Thus, a complete meta-loss function can be defined as:

$${J}_{META} = {\sum }_{{t}^{′} = t}^{t + k} {‖ {p}_{{t}^{′}} - d ‖}_{2}^{2} + λ {\sum }_{{t}^{′} = t}^{t + k} {R}_{H L} ( {p}_{{t}^{′}} , d , {n}_{{t}^{′}} ) , \qquad ( 14 )$$

where λ describes the weighting parameters, and n_{t′} is the randomly generated data. By minimizing equation (12), a condition is imposed on the ML-misfit function to converge faster in reducing the residuals, and as a result, effectively mitigate the cycle-skipping. The regularization term of the Hinge loss function and the L1 norm make the training process more stable and robust.

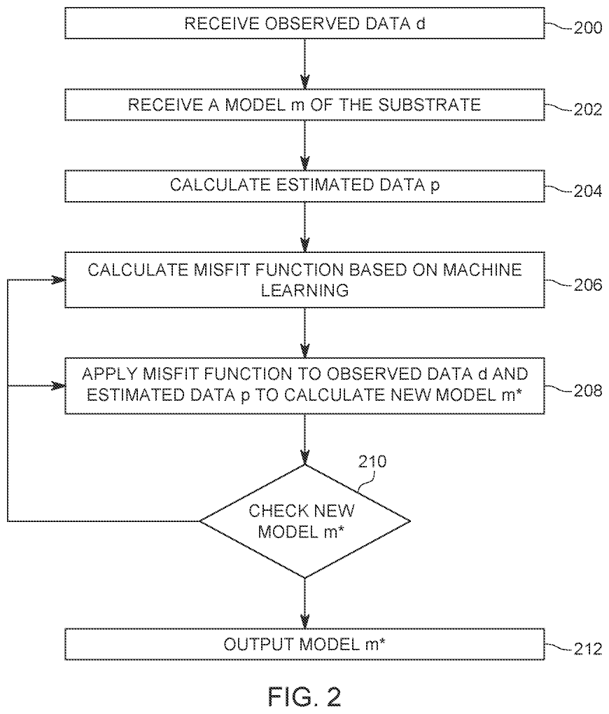

A method for calculating the waveform inversion in the context of a model m that describes the subsurface and a source s that is responsible for generating the seismic wavefields is now discussed with regard to FIG. 2. The method starts in step 200, in which the observed data d is received. For a seismic case, the observed data d may be recorded with a seismic sensor, over land or in a marine environment. The observed data d is acquired during a seismic survey. In step 202, a model m of the substrate is received. The model m can be deduced by the operator of the method or it can be imported from any other previous seismic survey. The model m may be constructed based on previously known seismic data. In step 204, the method calculates the estimated data p, based on the model m and the forward operator, as noted in equation (A).

In step 206, a misfit function is calculated using a neural network system. The neural network system improves the misfit function until a desired misfit function J_{ML} is obtained. The desired misfit function J_{ML} is obtained by using a machine learning technique, as discussed above. In one application, the meta-learning is used to calculate the misfit function J_{ML}, as discussed above.

In step 208, the learned misfit function J_{ML} is applied to the observed data d and to the estimated data p to estimate the misfit between these two sets of data, and calculate an updated (or new) model mₜ₊₁ and/or a new source sₜ₊₁. The updated model mₜ₊₁ describes the properties of the physics of the surveyed subsurface and is used to determine an oil or gas reservoir in the subsurface. In one embodiment, the new model mₜ₊₁ is calculated as follows. According to equation (7), the adjoint source δs is calculated as the derivative of the misfit function J_{ML} with the predicted data p. Then, based on equation (8), the new model mₜ₊₁ is calculated using the RTM operator applied to the adjoint source δs.

The method then advances to step 210, wherein the new model mₜ₊₁ and/or a new source sₜ₊₁ are used to recalculate the estimated data p. If the estimated data p is within a desired value from the observed data d, the method stops and outputs the new model mₜ₊₁ and/or the new source sₜ₊₁. Otherwise, the model returns either to step 208 to apply again the misfit function J_{ML} to the observed data d and the new estimated data p, or returns to step 206 to further calculate (refine) the misfit function J_{ML}, based on an updated neural network parameter θ_{new}. The specific procedure for updating the misfit function J_{ML} is discussed next.

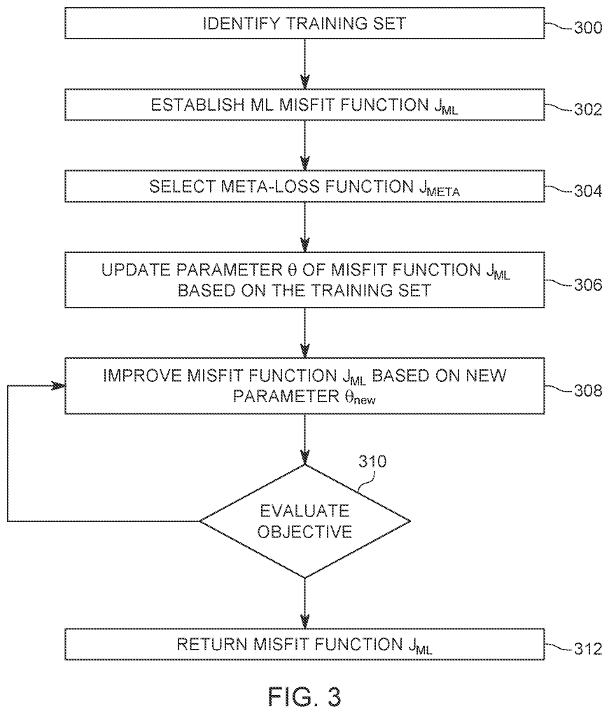

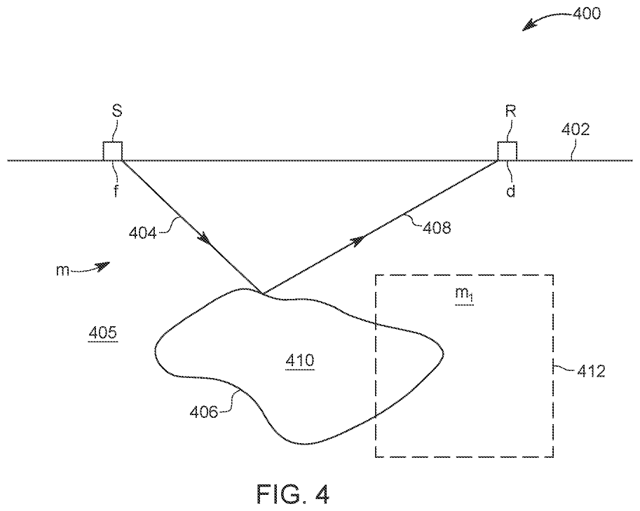

The training of the neural network for calculating the misfit function J_{ML} in step 206 is now discussed with regard to FIG. 3. In step 300, a training set of the medium parameter models m is identified. The training set may include models from previous seismic surveys. In one application, a single model m is obtained from another seismic survey and one or more parameters of the model are randomly changed to generate the set of models. In one application, the training set includes between 2 and 100 models. In still another embodiment, it is possible to obtain the model m for the entire subsurface and then to take various portions of the model m (i.e., for various patches of the subsurface) for generating the training set. In this regard, FIG. 4 shows a seismic survey 400 that includes a seismic source S and a receiver R that are located at the earth's surface 402. The seismic source S emits a wavefield 404 (seismic wave) that propagates through the subsurface 405 until encountering an interface 406, where the speed of the seismic wave changes. At that point, the incoming wavefield 404 is reflected and/or refracted and an outgoing wavefield 408 is generated, which is recorded by the receiver R. The interface 406 may define an oil and gas reservoir 410. Other interfaces may exist in the subsurface 405 that are not associated with oil or gas. The model m describes the physics associated with the entire subsurface 405 and the interaction between the subsurface and the seismic waves 404 and 408. If only a patch 412 of the subsurface 405 is considered, then a smaller model m′ is necessary to describe the patch. By taking plural patches of the subsurface 405, it is possible to generate the training set discussed above.

In step 302, the ML misfit function J_{ML} is established, for example, as illustrated in equation (1). This means that the ML misfit function J_{ML} is set up to be generated by a machine learning procedure. The ML misfit function J_{ML} has the parameter θ, that needs to be updated to improve the ML misfit function J_{ML}. In one application, a meta-loss function J_{META}, as defined by equation (9) or (10) is selected in step 304 for updating the parameter θ. Other functions may be selected. The meta-loss function J_{META} is selected to depend on a difference between (i) the observed data d or the true model mₜᵣᵤₑ that describes the subsurface, and (ii) the predicted data p or the updated model mₜ₊₁, respectively. Then, in step 306, the meta-loss function J_{META} is run iteratively on the training set of models m to update the parameter θ. The training set of models m is used together with equation (11) to update the NN parameter θ to obtain the new parameter θ_{new}. Then, in step 308, the misfit function J_{ML} is improved by using the new parameter θ_{new}, obtained with equation (11).

In step 310, the meta-loss function of the model residual is evaluated. If the result is not below a given threshold, the method returns to step 308 to further improve the misfit function J_{ML}. However, if the misfit function J_{ML} has reached the desired objective, the method returns in step 312 the misfit function J_{ML}, which can be used in step 206 of the method illustrated in FIG. 2.

The method illustrated in FIG. 3 may optionally include a step of verifying that the misfit function J_{ML} is a metric (i.e., obeys equations (2) to (4)). Further, the method may also include a step of imposing the triangle inequality rule (see equation (5)) on the misfit function J_{ML}. In case that the misfit function does not respect the inequality rule, it can be regularized by adding a Hinge loss regularization as illustrated in equation (6).

In another embodiment, it is possible to build a neural network for directly mapping the predicted data pₜ and the observed data dₜ to avoid the derivative noted in equation (7). In this regard, note that the purpose of designing the misfit function J_{ML} in the previous embodiment was to produce the adjoint source δsₜ in equation (7) for better fitting of either the model (equation (9)) or the data (equation (10)). According to equation (7), the adjoint source δs is the derivative of the misfit function J_{ML} with respect to the predicted data pₜ. Thus, it is possible to build a neural network to map the predicted data pₜ and dₜ directly to the adjoint source to avoid such derivatives, i.e., by using equation:

δs=Φ′(p,d; θ′), (15)

where Φ′ represents a neural network and θ′ is the parameter of the neural network. The training of the neural network Φ′ is similar to the training illustrated in FIG. 3, i.e., evaluating the meta-loss misfit function given by equation (9) or (10) and then using a gradient descent method for updating the parameter θ′ (equation (11)). One benefit of directly learning an adjoint source is avoiding the high-order derivative when updating the parameter θ′. This is so because in this embodiment the adjoint source is computed directly, not as the derivative of the misfit function (equation (7)). This approach improves the efficiency and robustness of the training.

An example of illustrating the properties of the learned ML-misfit function is now discussed with respect to time shift signals. This example is also used to analyze the effect of the Hinge loss function on the resulting learned misfit. In this embodiment, the objective is to optimize a single parameter, i.e., the time shift between seismic signals. An assumed forward modeling operator produces a shifted Ricker wavelet, having the following form:

F(t; τ,f)=[1−2π²f²(t−τ)²]e^{-π}^{²}^{f}^{²}^{(t-τ)}^{²}, (16)

where τ is the time shift and f is the dominant frequency. The model given by equation (16) is a simplified version of the modeling using PDE.

Suppose that the true shift is τₜᵣᵤₑ and the current inverted time shift is τ. The time shift is interpolated based on a uniformly generated random number ϵ to obtain a random time shift τₙ, and thus, the meta-loss function is defined as:

$${J}_{META} = \frac{1}{2} {( {τ}_{true} - τ )}^{2} + λ {R}_{H L} [ F ( t ; τ , s ) , F ( t ; {τ}_{true} , s ) , F ( t ; {τ}_{n} , s ) ] , \qquad ( 17 )$$

where λ is a weighting parameter, the unroll parameter is 10 (i.e., the method accumulates the meta-loss value for 10 steps and then back-propagates the residual to update the neural network), and the summation over the multiple steps is omitted. The first term is used to guide the resulting ML-misfit function to achieve a fast convergence to the true time shift. The R_{HL} is the Hinge loss function defined in equation (6). The method interpolates the true travel time shift Tₜᵣᵤₑ and the current inverted travel time shift τ to obtain an extra travel time shift τₙ and then uses this interpolated travel time shift to model the data and further insert it into the Hinge loss function. This makes the modeled data F(t; τₙ, δs) a shifted version of F(t; τ, δs) and F(t; τₜᵣᵤₑ, δs) so that that the Hinge loss function can take into account such time shift features. Besides, a linear interpolation makes the resulting Hinge loss function smaller when r is closer to the true one and this is consistent with the first term, which becomes smaller as well. Thus, this strategy of applying the Hinge loss function makes the selection of the weighting parameter A easier and also stabilizes the training process.

In this example, the data is discretized using nt=200 samples with a time sampling dt=0.01 s. The method uses a direct connected network (DCN) for the function Φ in the ML-misfit function defined by equation (1). The size of the input for Φ is 2*nt, which acts as one vector, but made up of two vectors with size nt. From trial and error, the DCN was set to include four layers, the output size for each of the layers are 200, 100, 100, and 2, respectively.

The method inverted for sixty time-shift inversion problems simultaneously (the true time-shifts are generated randomly for each epoch and its value are between 0.4 s and 1.6 s). 100 iterations were run for each optimization and every 10 iterations (unroll parameter k=10), the method updated the neural network parameters. For training the neural network, the RMSprop algorithm was used and the learning rate was set to be relatively small (5.0E-5). A dropout of 1% neural output is applied after the second layer to reduce the overfitting. The weighting parameter A was set to 2 for the Hinge loss function. No other regularization was applied to the coefficients of the NN in this example. Another sixty time-shift inversion problems were created for testing. The true time-shifts for testing are also randomly generated with values between 0.4 s and 1.6 s and the testing dataset is fixed during the training.

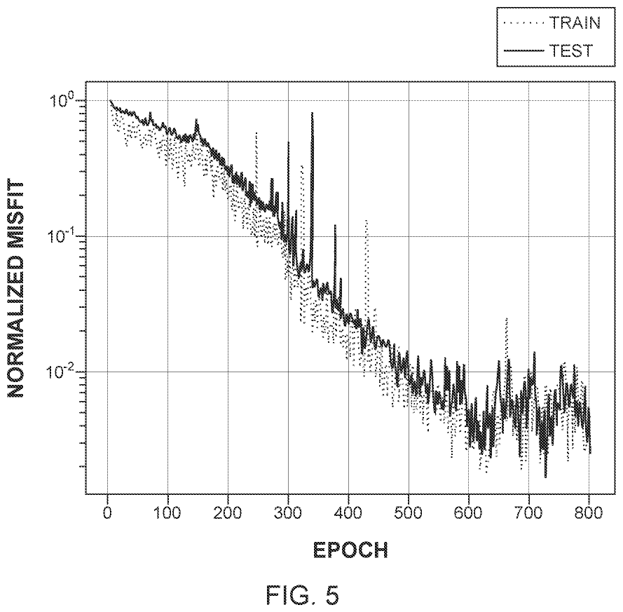

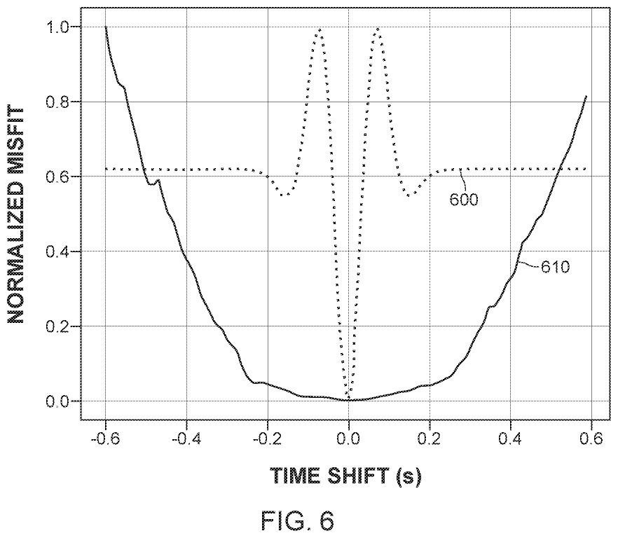

FIG. 5 shows the training and testing curves over the epochs. The continuous reduction in the loss for the training and testing sets demonstrates the good convergence for training of the ML-misfit neural network. To evaluate the performance of the resulting ML-misfit, its convexity was checked with respect to the time-shifted signal. Specifically, the misfit between a target signal and its shifted version for a varying time-shifts was computed. FIG. 6 shows the resulting objective functions for the L2 norm (curve 600) and the trained ML-misfit (curve 610). The target signal is a Ricker wavelet (as in equation (16)) with a dominant frequency of 6 Hz, and the time-shifts with respect to the target signal varies from −0.6 s to 0.6 s. It is noted that the ML-misfit function J_{ML} (corresponding to curve 610) learnt by a machine shows a much better convexity than the L2-norm misfit (curve 600).

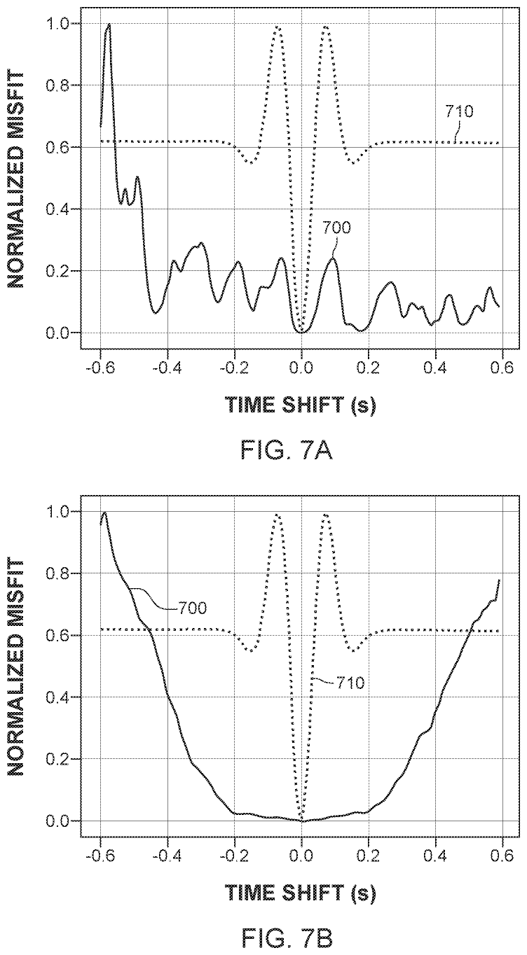

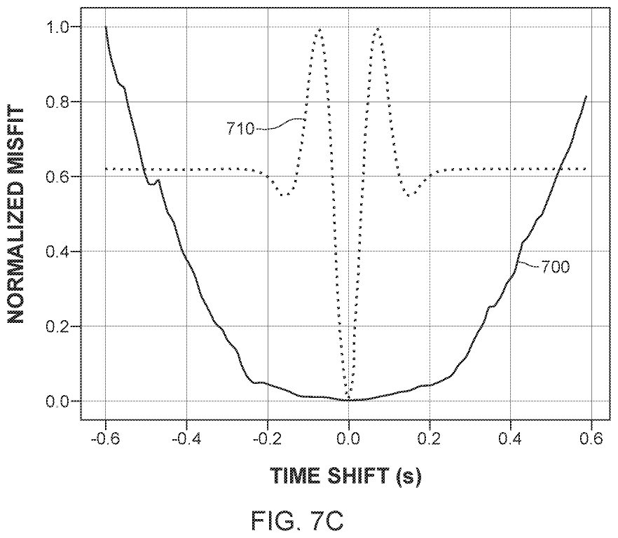

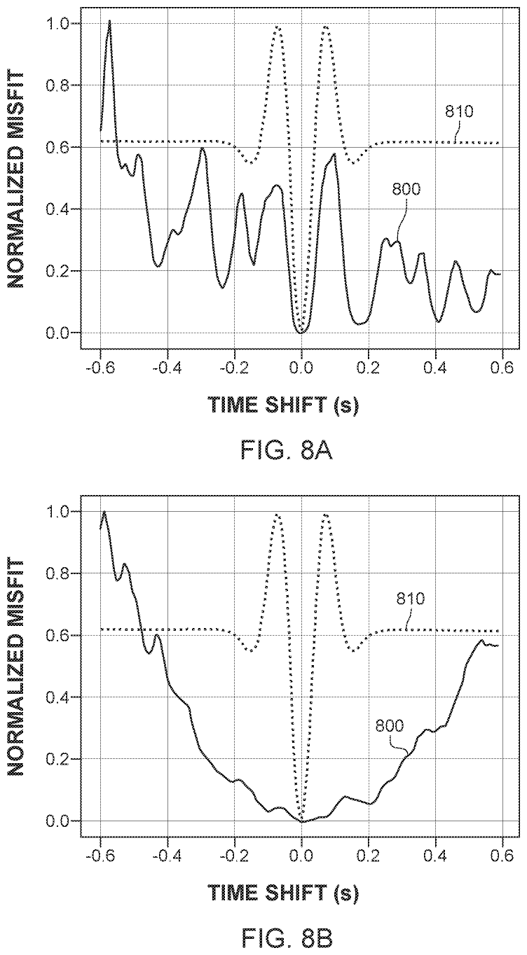

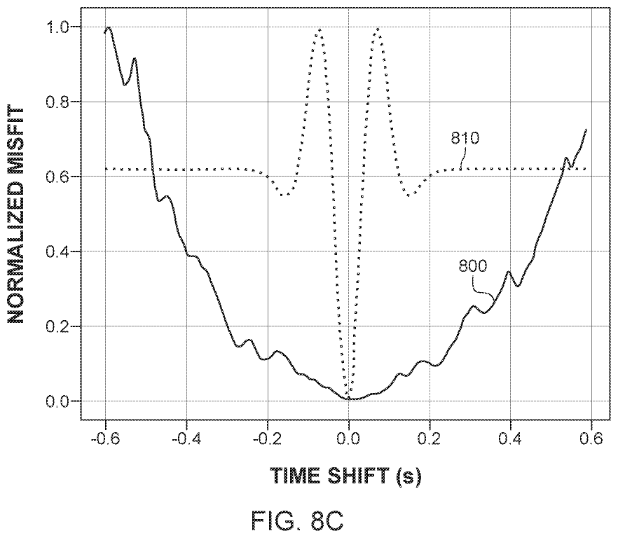

In this regard, FIGS. 7A to 7C show how the convexity feature evolves when the training of the neural network proceeds. FIG. 7A shows the ML-misfit function 700 compared to the L2 norm misfit 710 after 1 epoch training, while FIG. 7B shows the same after 400 epoch training and FIG. 7C shows the same after 800 epoch training. All the ML-misfit functions in these figures include the Hinge loss function. To illustrate the importance of the Hinge loss function, the NN was re-train using the same setup as before, but excluding the Hinge loss regularization. The evolution of the convexity feature for the ML-misfit function 800 and the L2 norm misfit 810 are illustrated in FIGS. 8A to 8C. When compared to FIGS. 7A to 7C, one can observe immediately that the misfits in FIGS. 8A to 8C without the Hinge loss regularization have a slow recovery of the convexity feature.

This illustrative example demonstrates that based on the ML-misfit function framework proposed in the above discussed embodiments, it is possible to learn a misfit function using a machine, which can incorporate the feature embedded in the dataset and as a result provide desired features for the misfit function, such as improved convexity for a potential optimization utilization.

Although the embodiments discussed herein used a specific ML-misfit function (equation (1)), the proposed approach provides a general framework for learning a misfit function in inverse problems. One skilled in the art would understand, after reading the present disclosure, that there are many possibilities for generalizing the ML-misfit function introduced by equation (1). For example, it is possible to define the NN architecture as a black box that is described by:

J_{ML}(p,d)=Φ(p,d; θ). (18)

This ML-misfit function has no symmetry, which is different from the function introduced by equation (1). In this approach, the machine will learn on its own to produce a symmetric ML-misfit function.

In another embodiment, instead of using DCN for the NN Φ as in the above embodiments, conventional neural networks (CNN) or recurrent neural network (RNN) can also be used. While the above embodiments use a shallow network for the NN Φ, deeper networks using the ResNet framework can be utilized for improving the accuracy and robustness of the resulting ML-misfit function.

The input to the ML-misfit network introduced in equation (1) is a 1D trace signal. However, other ensembles of data can be used, for example, a common shot, common receiver, common mid-point, common azimuth or any other combination.

The input to the ML-misfit function described by equation (1) is in the time domain. The input can be transformed to other domains before being supplied to the ML-misfit function, for example, the time-frequency domain, Fourier domain, Wavelet domain, Radon domain, etc.

The training of the NN of the ML-misfit function discussed above is based on meta-learning, In one embodiment, it is possible to use another type of training, for example, reinforcement learning for training such NN.

Thus, a machine-learned misfit function, which is neural network (NN) trained, to measure a distance between two data sets in an optimal way for inversion purposes is disclosed in these embodiments. The input to the NN is the observed and predicted data, and the output is a scalar identifying the distance between the two data sets. The scalar output (and its derivative regarding to the input) and the network are then used to obtain an update for the model m under investigation. In one embodiment, the NN is trained by minimizing the least-squares difference between the observed and simulated data. In another embodiment, the NN can also be trained by minimizing the least-square difference between the true and inverted model. For efficient training, in one embodiment, the NN is trained on a 1D model in a way that can represent both transmission and scattered wavefields. For training the NN, it is possible to either use a gradient-descent based algorithm or a model-free reinforcement learning approach. In one embodiment, a specific NN architecture is selected for the misfit function, which in principle mimics reducing the mean and variance of the resulting matching filter distribution as in the OTMF approach. A symmetry can be introduced in the NN and a Hinge loss function in the meta-loss to ensure that the resulting misfit function is a metric (distance) and this will reduce the function space for searching in the training step and improve the robustness of resulting learned misfit.

In another embodiment, rather than learning a misfit function that can only avoid cycle-skipping to accelerate the convergence of the optimization, the learned misfit function can be used to mitigate the physical difference between the actual dataset (which was acquired in the field by measurements) and the engine used to model the data. This approach suggests training the neural network with the measured dataset with more complex physics (such as including elasticity, anisotropy and/or attenuation), and the predicted data are simulated with simplified physics (using for example the acoustic pressure wave equation).

In general, optimization problems include regularization terms applied for example to the model (i.e., applying a total variation minimization of the model). The invention in one embodiment is applicable to predict or measure a regularization to help regularize the model. A neural network is trained to take in a model and output its regularization measure given by a scalar as part of the optimization. The meta-loss, if meta learning is used for this objective, could also be data fitting or model fitting using for example a least square misfit. By training the neural network with data corresponding to various acquisition scenarios and models, the resulting learned regularization can compensate limitations in the acquisition and potentially recover high resolution models.

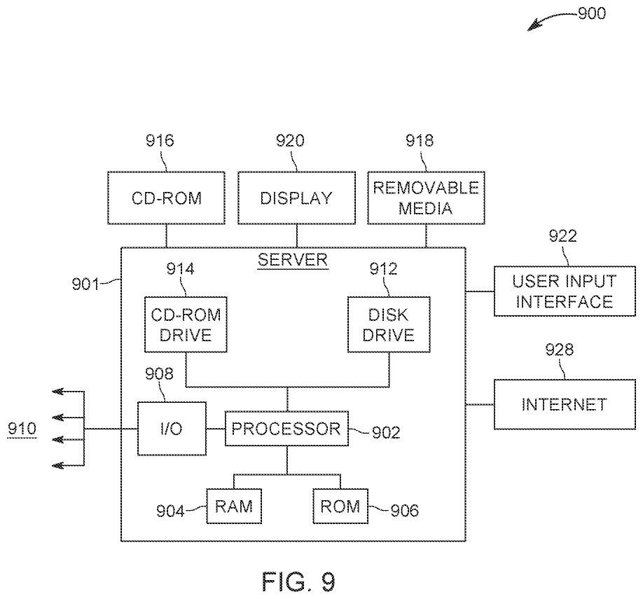

The above-discussed procedures and methods may be implemented in a computing device as illustrated in FIG. 9. Hardware, firmware, software or a combination thereof may be used to perform the various steps and operations described herein. Computing device 900 of FIG. 9 is an exemplary computing structure that may be used in connection with such a system.

Exemplary computing device 900 suitable for performing the activities described in the exemplary embodiments may include a server 901. Such a server 901 may include a central processor (CPU) 902 coupled to a random access memory (RAM) 904 and to a read-only memory (ROM) 906. ROM 906 may also be other types of storage media to store programs, such as programmable ROM (PROM), erasable PROM (EPROM), etc. Processor 902 may communicate with other internal and external components through input/output (I/O) circuitry 908 and bussing 910 to provide control signals and the like. Processor 902 carries out a variety of functions as are known in the art, as dictated by software and/or firmware instructions.

Server 901 may also include one or more data storage devices, including hard drives 912, CD-ROM drives 914 and other hardware capable of reading and/or storing information, such as DVD, etc. In one embodiment, software for carrying out the above-discussed steps may be stored and distributed on a CD-ROM or DVD 916, a USB storage device 918 or other form of media capable of portably storing information. These storage media may be inserted into, and read by, devices such as CD-ROM drive 914, disk drive 912, etc. Server 901 may be coupled to a display 920, which may be any type of known display or presentation screen, such as LCD, plasma display, cathode ray tube (CRT), etc. A user input interface 922 is provided, including one or more user interface mechanisms such as a mouse, keyboard, microphone, touchpad, touch screen, voice-recognition system, etc.

Server 901 may be coupled to other devices, such as sources, detectors, etc. The server may be part of a larger network configuration as in a global area network (GAN) such as the Internet 928, which allows ultimate connection to various landline and/or mobile computing devices.

The disclosed embodiments provide a neural network based misfit function for use in inverse problems, especially in full waveform inversion used in the seismic field. The neural network is trained with existing models of the subsurface of the earth and then an improved misfit function is generated for each specific problem. While the above embodiments are discussed with regard to the seismic field, one skilled in the art would understand that this method can be applicable to any field in which an inversion process is necessary. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Schmidhuber, J., 1987, Evolutionary principles in self-referential learning. On learning how to learn: The meta-meta-meta . . . -hook: Diploma thesis, Technische Universitat Munchen, Germany.
[2] Vilalta, R., and Y. Drissi, 2002, A perspective view and survey of meta-learning, Artificial Intelligence Review, 18, 77-95.
[3] Sun, B., and T. Alkhalifah, 2019, The application of an optimal transport to a preconditioned data matching function for robust waveform inversion: Geophysics, 84, no. 6, R923-R945.

1. A method for waveform inversion, the method comprising:
receiving observed data d, wherein the observed data d is recorded with sensors and is indicative of a subsurface of the earth;
calculating estimated data p, based on a model m of the subsurface;
calculating, using a trained neural network, a misfit function J_{ML}; and
calculating an updated model mₜ₊₁ of the subsurface, based on an application of the misfit function J_{ML} to the observed data d and the estimated data p.

2. The method of claim 1, wherein the observed data d is seismic data related to the subsurface of the earth, and the updated model mₜ₊₁ describes parameters of the subsurface based on an assumed physics.

3. The method of claim 1, wherein the updated model mₜ₊₁ is used to determine a presence of an oil or gas reservoir.

4. The method of claim 1, wherein the misfit function J_{ML} depends on a neural network parameter θ.

5. The method of claim 4, wherein the misfit function J_{ML} includes a first term that is described by two layers in the neural network.

6. The method of claim 5, wherein the first term is a difference between (1) a neural network layer Φ having as input the observed data d and the estimated data p, and (2) a neural network layer Φ having as input the observed data d and the observed data d.

7. The method of claim 5, wherein the misfit function J_{ML} further includes a second term that is described by the two layers in the neural network.

8. The method of claim 7, wherein the second term is a difference between (1) a neural network Φ having as input the observed data d and the estimated data p and (2) a neural network Φ having as input the estimated data p and the estimated data p.

9. The method of claim 1, wherein the misfit function J_{ML} is regularized with a Hinge loss function.

10. The method of claim 1, wherein the step of calculating an updated model mₜ₊₁ of the subsurface comprises:
calculating a derivative of the misfit function J_{ML} with the estimated data p, to obtain an adjoint source δs; and
applying an inverse Born or a reverse time migration to the adjoint source s and combining a result of this operation with the model m to obtain the updated model mₜ₊₁.

11. A computing device for waveform inversion, the computing device comprising:
an interface configured to receive observed data d, wherein the observed data d is recorded with sensors and is indicative of a subsurface of the earth; and
a processor connected to the interface and configured to,
calculate estimated data p, based on a model m of the subsurface;
calculate, using a trained neural network, a misfit function J_{ML}; and
calculate an updated model mₜ₊₁ of the subsurface, based on an application of the misfit function J_{ML} to the observed data d and the estimated data p.

12. The computing device of claim 11, wherein the processor is further configured to:
calculate a derivative of the misfit function J_{ML} with the estimated data p, to obtain an adjoint source δs; and
apply a reverse time migration to the adjoint source δs and combining a result of this operation with the model m to obtain the updated model mₜ₊₁.

13. A method for calculating a learned misfit function J_{ML} for waveform inversion, the method comprising:
selecting an initial misfit function to estimate a distance between an observed data d and an estimated data p, wherein the initial misfit function depends on a neural network parameter θ, the observed data d, and the estimated data p, which are associated with an object;
selecting a meta-loss function J_{META} that is based on the observed data d and the estimated data p;
updating the neural network parameter θ to obtain a new neural network parameter θ_{new}, based on a training set and a derivative of the meta-loss function J_{META}; and
returning a learned misfit function J_{ML} after running the new neural network parameter θ_{new} in a neural network for the initial misfit function.

14. The method of claim 13, wherein the meta-loss function J_{META} is an L2 norm of a difference between the observed data d and the estimated data p.

15. The method of claim 13, wherein the meta-loss function J_{META} is an L2 norm of a difference between an updated model mₜ₊₁ and a true model mₜᵣᵤₑ of the object.

16. The method of claim 13, wherein the new neural network parameter θ_{new} is calculated as a difference between the neural network parameter θ and a derivative of the meta-loss function J_{META} with the neural network parameter θ.

17. The method of claim 13, wherein a Hinge loss function is added to the meta-loss function J_{META} to regularize the meta-loss function J_{META}.

18. The method of claim 13, wherein the observed data is seismic data related to a subsurface of the earth and the estimated data is calculated based on a model m of the subsurface, wherein the model m describes a physics of the subsurface.

19-21. (canceled)
